(19) United States
(12) Patent Application Publication
(10) Pub. No.: US 2026/0287926 A1
(43) Pub. Date: Sep. 24, 2026

(54) HINGE FOR SPECTACLE FRAMES AND RELATED ASSEMBLY METHOD

(71) Applicant: LUXOTTICA S.R.L., Agordo (BL) (IT)

(72) Inventor: Moreno DAL PONT, Belluno (BL) (IT)

(73) Assignee: LUXOTTICA S.R.L., Agordo (BL) (IT)

(21) Appl. No.: 19/471,765

(22) PCT Filed: Apr. 2, 2024
(86) PCT No.: PCT/IB2024/053179

§ 371 Date: Oct. 2, 2025

(30) Foreign Application Priority Data
Apr. 3, 2023 (IT) 102023000006519

(51) Int. Cl. G02C 5/22

(52) U.S. Cl. CPC G02C 5/2209

(57) ABSTRACT

A hinge for spectacle frame, said frame providing a frame front portion and a pair of temples, laterally coupled to said frame front portion, each coupling between frame front portion and temple providing a hinge, said hinge being characterized by providing a female element, substantially circular, with a circular central opening, equipped with a seat on its side surface, a male element, substantially circular, with a circular central opening, insertable into said seat of said female element, and a coupling element between said female element and said male element, substantially circular, equipped with at least three engaging portions and at least three vertical grooves, said male element being equipped with a number of protuberances corresponding to the number of said engaging portions and vertical grooves provided on said coupling element, said coupling element being insertable into said openings of said female and male elements.

The present invention relates to a hinge for spectacle frame.

In more detail, the invention relates to a hinge of the said type which provides no fixing screws.

The invention further relates to a method of assembling said hinge.

As known, normally used hinges for spectacle frames, namely hinges arranged between the frame front portion supporting the side temples and the lenses, and which allow, in addition to coupling between frame and temples, the respective rotation, generally provide a complex of screws and/or rotating elements.

These are solutions which, as is apparent, although used for decades, involve a complexity in the initial mounting step, a certain delicacy during the use, whereby the user could proceed to operations for reinforcing the various elements composing the hinge, as well as the risk that the same is demounted, and that some pieces are lost, thus making the frame no longer usable.

Not least should be considered the aesthetic appearance of the hinge itself. Reducing the number of components and/or the possibility to show logos, images, and/or customizations are particularly sensitive themes regarding the recently-developed hinges.

In light of the above, the Applicant made a hinge for spectacle frames standing between the frame front portion and the related temples, also allowing to open and close the same temples with respect to the frame front portion, and which provides no screws for being assembled.

These and other results are obtained, according to the present invention by a hinge for spectacle frame according to independent claim 1.

Further features of the hinge according to the invention are specified in dependent claims 2-6.

The invention further relates to a method of assembling said hinge as claimed in independent claim 7.

The present invention will be described, for illustrative but non-limiting purposes, according to preferred embodiments thereof, illustrated in the figures of the attached drawings, wherein:

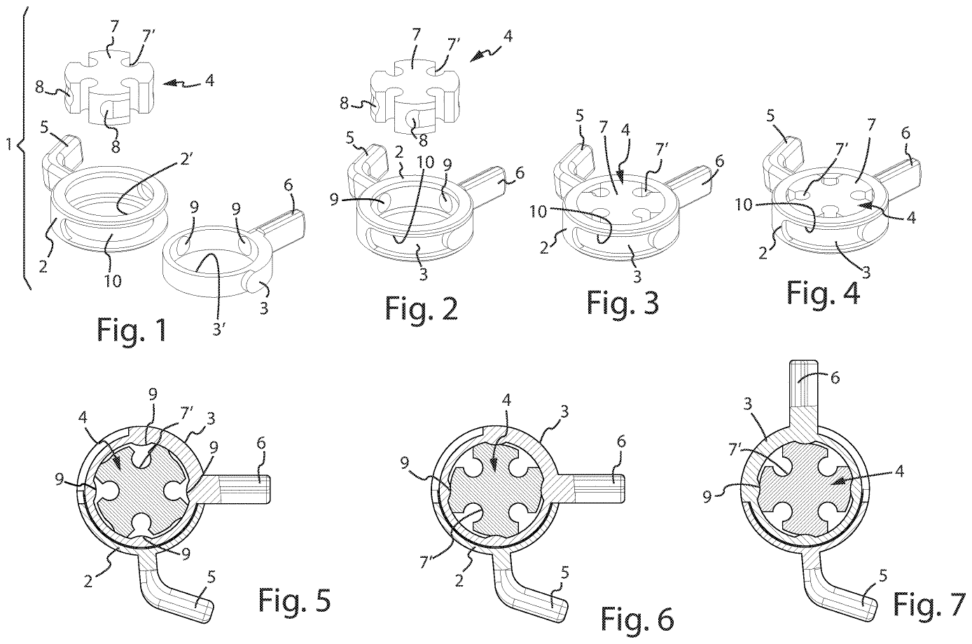

FIG. 1 is an exploded view of a first embodiment of a hinge for spectacle frames according to the invention;

FIGS. 2, 3 and 4 show the hinge of FIG. 1 in the various assembling steps;

FIGS. 5, 6 and 7 are sectional views of the hinge of FIG. 1, of the assembling steps shown in the preceding FIGS. 2-4;

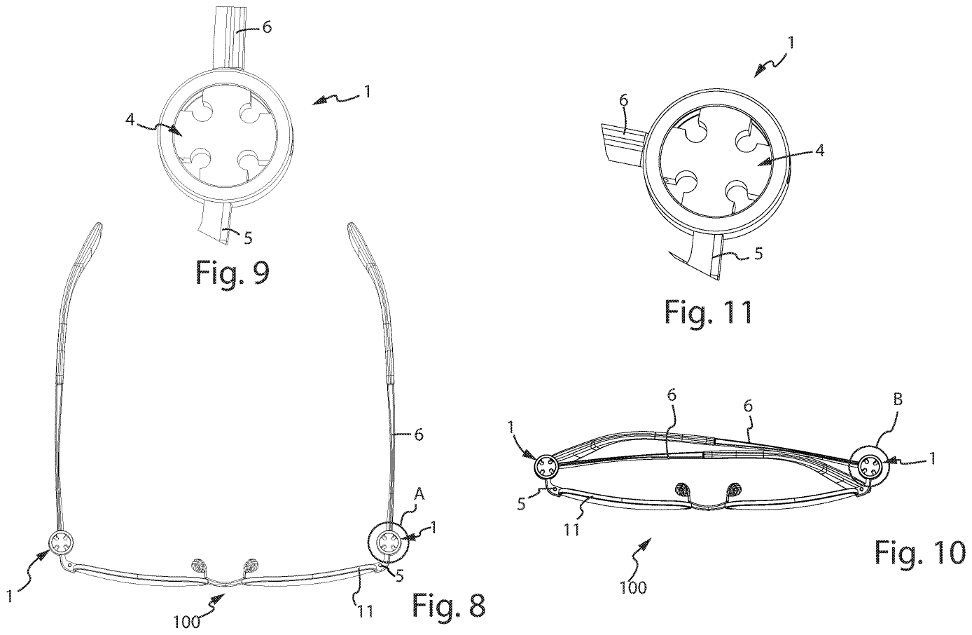

FIG. 8 is a top view of a frame with open temples which provides two hinges as illustrated in the preceding figures;

FIG. 9 shows the detail A of FIG. 8;

FIG. 10 is a top view of a frame with closed temples which provides two hinges as illustrated in the preceding figures;

FIG. 11 shows the detail B of FIG. 10;

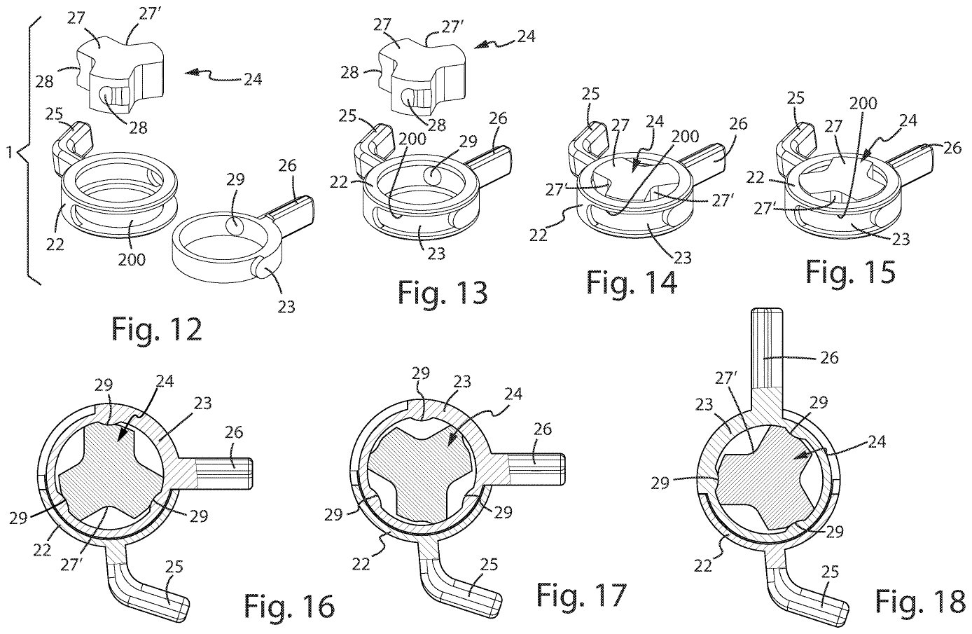

FIG. 12 is an exploded view of a second embodiment of a hinge for spectacle frames according to the invention;

FIGS. 13, 14 and 15 show the hinge of FIG. 12 in the various assembling steps;

FIGS. 16, 17 and 18 are sectional views of the hinge of FIG. 1, of the assembling steps shown in the preceding FIGS. 13-15;

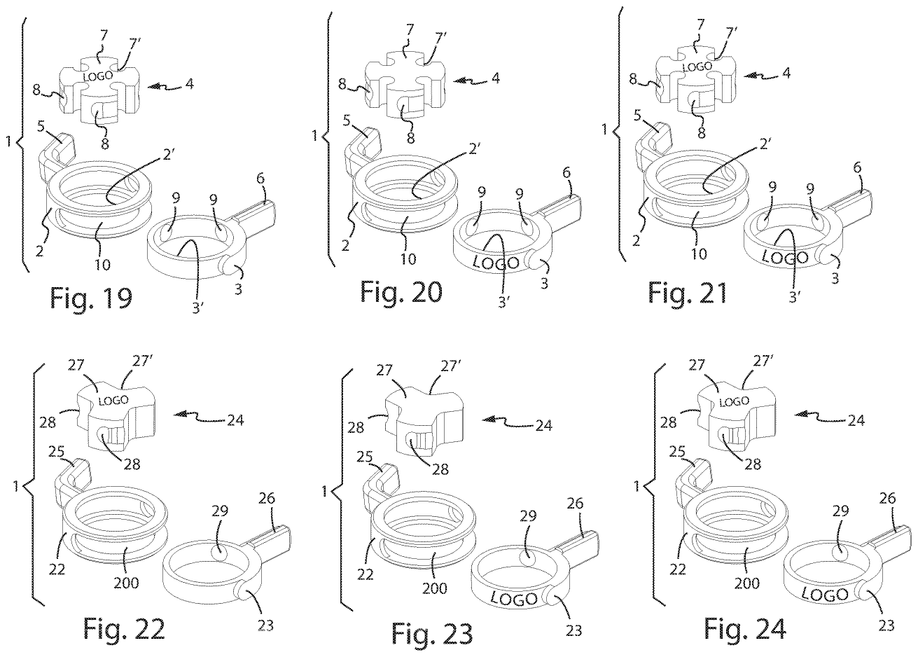

FIGS. 19, 20 and 21 are exploded views of the first embodiment of the hinge according to the invention with writings or logos on parts of the same; and

FIGS. 22, 23 and 24 are exploded views of the second embodiment of the hinge according to the invention with writings or logos on parts of the same.

Firstly, observing FIG. 1 of the attached drawings, an embodiment of a hinge according to the invention is shown, generally indicated by reference number 1, which provides a first female element 2, substantially circular, having a circular central opening 2′, a second male element 3, also substantially circular, having a circular central opening 3′, and an element 4 for coupling and respectively fixing said elements 2 and 3. In this embodiment (as will be better seen with reference to FIGS. 8-11), the female element 2 is integrally coupled to the frame front portion, by an arm 5, while the male element 3 is directly coupled to the temple 6 of the frame itself. However, it is apparent that the couplings can be safely opposed (female element 2 and temple 6 and male element 3 and arm 5), without modifying in any way the effects and results obtained by the solution according to the invention.

The element 4 for coupling and respectively fixing said elements 2 and 3 has, in this embodiment, a structure with four engaging portions 7, and four vertical grooves 7′, all contained inside an imaginary circumference being coupled inside said substantially circular female element 2. Each of the engaging portions 7 provides a recess or cavity 8 adapted to provide a seat for engaging the protuberances 9 of the male element 3. In this embodiment, being provided four engaging portions 7, the recesses 8 are arranged each 90° with respect to said imaginary circumference.

Correspondingly, four protuberances 9, corresponding in number and offset to those of said recesses 8, are provided inside said male element 3.

Observing now FIGS. 2 to 7 of the attached drawings, it will be apparent how the hinge 1 is assembled according to the invention, and the functionality and absolute reliability thereof.

Firstly (FIG. 2), the two female 2 and male 3 elements are coupled. For this purpose, the female element 2 is equipped on the circumference with a seat 10 wherein the male element 3 is engaged.

Then (FIG. 3), the coupling element 4 is inserted from above, through said circular central openings 2′, 3′, with said grooves 7′ aligned with respect to said protuberances 9.

Once completed this operation, by means of a tool (not shown) or by hand, the coupling element 4 is rotated (in this embodiment by 45°) (see FIG. 4), such that the protuberances 9 are forced into the recesses 8, thus making a mechanical coupling and a related respective fixing of the elements 2, 3 and 4 of the hinge 1 according to the invention, which allows the rotation thereof.

Such fixing operation is also visible from FIGS. 5, 6 and 7, in section.

Observing now FIGS. 8, 9, 10 and 11, a frame, generally indicated by reference number 10, which provides, as normal, a frame front portion 11, and two temples 6 is shown.

A hinge 1 according to the invention is provided at the coupling between each temple 6 and the frame front portion 11.

It should be noted that the hinge 1 according to the invention, without screws, is strongly fixed to the front portion 11 and the respective temple 6 and allows (see particularly FIGS. 10 and 11) the temples 6 to be closed with respect to the front portion 11, when the spectacle frame 100 is not worn by the user.

In FIGS. 12 to 17 a second embodiment of the hinge according to the invention is shown, in this case generally indicated by reference number 21, wherein the elements equal or similar to those described in the preceding claims are indicated by the same reference numbers, preceded by number 2.

The same elements of the first embodiment will not be described in detail again, and only the differences between the first and the second embodiments will be highlighted.

The main difference between the second embodiment and the first embodiment is that the element 24 for coupling and respectively fixing said elements 22 and 23 provides three engaging portions 27, and three vertical grooves 27′, all contained inside an imaginary circumference being coupled inside said substantially circular female element 22. Each of the engaging portions 27 provides a recess or cavity 28. Being provided three engaging portions 27, the recesses 28 are arranged each 120° with respect to said imaginary circumference.

Correspondingly, three protuberances 29, corresponding in number and offset to those of said recesses 28, are provided inside said male element 23.

The assembling of this second embodiment of the hinge 21 is identical to that already described with reference to the first embodiment, with the only difference that the rotation of the coupling element 24 by means of the tool or by hand in this case provides a 60° rotation.

The element 24 is preferably made of plastic or bioplastic material. The male and female elements can be made of plastic or metal material.

From the above, those skilled in the art can easily understand that a number of the engaging portions other than three or four can be also provided without this being considered outside the scope of protection attributable to the present invention.

As observed in FIGS. 19-21 and 22-24, in a non-using condition, or with closed temple, desired writings, images, or logos can be shown on the hinge portion 3; 23. Such writings or logos can be suitably etched or juxtaposed without creating thicknesses.

Furthermore, the element 3; 23 can be easily demountable in order to promote a greater customization, for example of colours, writings, or images.

The present invention has been described, for illustrative but non-limiting purposes, according to preferred embodiments thereof, illustrated in the attached drawings, but it should be understood that each variation and/or modification being obvious for those skilled in the art should be considered as included in the scope of protection of the invention, as defined in the attached claims.

1. A hinge for a spectacle frame, said frame providing a frame front portion and a pair of temples laterally coupled to said frame front portion, each coupling between frame front portion and temple providing the hinge, said hinge comprising:
a female element, substantially circular, with a circular central opening, equipped with a seat on its side surface;
a male element, substantially circular, with a circular central opening, insertable into said seat of said female element; and
a coupling element between said female element and said male element, substantially circular, equipped with at least three engaging portions and at least three vertical grooves,
said male element being equipped with a number of protuberances corresponding to the number of said engaging portions and vertical grooves provided on said coupling element, each of said engaging portions providing a recess adapted to provide a seat for engaging the protuberances of the male element,
said coupling element being insertable into said openings of said female and male elements, when the latter are reciprocally coupled by inserting said male element into said seat of said female element, and
said coupling element being, once inserted into said female and male elements, rotatable to bring the recesses at said protuberances by forced rotation, thus obtaining a mechanical coupling between female element and male element, such that said female element and male element can reciprocally rotate.

2. The hinge according to claim 1, wherein said coupling element provides four engaging portions and four vertical grooves, and wherein said male element provides four protuberances.

3. The hinge according to claim 1, wherein said female element is coupled to said front portion of the frame and said male element is coupled to a temple of said frame.

4. The hinge according to claim 1, wherein said male element is coupled to said front portion of the frame and said female element is coupled to a temple of said frame.

5. The hinge according to claim 1, wherein said coupling element is made of plastic or bioplastic material.

6. The hinge according to claim 1, wherein said male and female elements are made of plastic or metal material.

7. A method of assembling a hinge for a spectacle frame, said frame providing a frame front portion and a pair of temples, laterally coupled to said frame front portion, each coupling between frame front portion and temple providing the hinge, said hinge including a female element, substantially circular, with a circular central opening, equipped with a seat on its side surface, a male element, substantially circular, with a circular central opening, insertable into said seat of said female element, and a coupling element between said female element and said male element, substantially circular, equipped with at least three engaging portions and at least three vertical grooves, said male element being equipped with a number of protuberances corresponding to the number of said engaging portions and vertical grooves provided on said coupling element, each of said engaging portions providing a recess adapted to provide a seat for engaging the protuberances of the male element, said coupling element being insertable into said openings of said female and male elements, when the latter are reciprocally coupled by inserting said male element into said seat of said female element, and said coupling element being, once inserted into said female and male elements, rotatable to bring the recesses at said protuberances, by forced rotation, thus obtaining a mechanical coupling between female element and male element, such that said female element and male element can reciprocally rotate, said method comprising:
coupling said female and male elements, by inserting the latter into slot laterally provided in said female element;
inserting from above said coupling element, with said grooves aligned with respect to said protuberances, in a complex consisting of the female element and male element; and
rotating, for example by means of a tool or by hand, said coupling element, so that the protuberances of said male element are forced into the recesses of the coupling element, thus making a mechanical coupling and a related respective fixing of the elements of the hinge which allows the rotation thereof.

8. The hinge according to claim 2, wherein said female element is coupled to said front portion of the frame and said male element is coupled to a temple of said frame.

9. The hinge according to claim 1, wherein said male element is coupled to said front portion of the frame and said female element is coupled to a temple of said frame.

10. The hinge according to claim 2, wherein said coupling element is made of plastic or bioplastic material.

11. The hinge according to claim 3, wherein said coupling element is made of plastic or bioplastic material.

12. The hinge according to claim 4, wherein said coupling element is made of plastic or bioplastic material.

13. The hinge according to claim 2, wherein said male and female elements are made of plastic or metal material.

14. The hinge according to claim 3, wherein said male and female elements are made of plastic or metal material.

15. The hinge according to claim 4, wherein said male and female elements are made of plastic or metal material.

16. The hinge according to claim 5, wherein said male and female elements are made of plastic or metal material.
